(19) United States
(12) Patent Application Publication
(10) Pub. No.: US 2025/0337241 A1
(43) Pub. Date: Oct. 30, 2025

(54) Method And Apparatus For Parameterizing Protective Devices Of A Power Supply Network

(71) Applicant: Siemens Aktiengesellschaft, München (DE)

(72) Inventors: Guosong Lin, Erlangen (DE); Thomas Hammer, Hemhofen (DE)

(73) Assignee: Siemens Aktiengesellschaft, München (DE)

(21) Appl. No.: 19/193,768

(22) Filed: Apr. 29, 2025

(30) Foreign Application Priority Data
Apr. 30, 2024 (EP) 24173280.9

(51) Int. Cl. H02J 3/08; G06Q 50/06

(52) U.S. Cl. CPC H02J 3/08; G06Q 50/06; H02J 2203/20

(57) ABSTRACT

An apparatus for operating protective devices of a power supply network with a plurality of switching devices to control power distribution, wherein switching states at a given time form a respective network state, and each protective device uses a network-state-specific parameter set to provide a desired protection function for said network state by way of the respective protective device. An example apparatus includes: means for calculating and building a database containing parameter sets, to supply the contents of the database of parameter sets of the power supply network, calculated in advance on the basis of predictions, to a control station of the power supply network and the protective devices. The processor receives, at regular time intervals, results of forecasts relating to probable network states and correspondingly appropriate currently adapted parameter sets and/or means for calculating their weighting.

### CROSS-REFERENCE TO RELATED APPLICATIONS

This application claims priority to EP Application Serial No. 24173280.9 filed Apr. 30, 2024, the contents of which are hereby incorporated by reference in their entirety.

### TECHNICAL FIELD

The present disclosure relates to power supply networks. Various embodiments of the teachings herein include systems and/or methods for parameterizing protective devices of a power supply network, to which a plurality of devices are connected, of which at least one receives power from the power supply network and at least one outputs power to the power supply network.

### BACKGROUND

When the switching states of a power supply network are changed, for example when a subnetwork is formed, the protective devices are reparameterized in order to adjust to the new network situation, the changed power flows. Basically, the number of network states does not grow linearly but exponentially with the number of switches present in a power supply network. Therefore, and as a result of the large number of small and decentralized power generators feeding surpluses into the power supply network, the changes in network states have recently multiplied. With this growing number of network states, problems arise at some point when reparametrizing the parameter sets of the protective devices so that the protection parameters are still set appropriately for each switching state.

The protection technology is not integrated into the operational management system as standard. The protective devices operate autonomously according to the parameterization thereof set by the protection technician during commissioning or in the event of a manual change. The parameter sets are calculated by the protection technician using suitable software packages. However, in this case there is no automation, i.e. automated adaptive network protection is not feasible using the current means.

As a rule, the parameter sets have until now been permanently installed once and then are no longer changed because there is hardly any change in the network situation. This has changed fundamentally in recent years. There are therefore many changes now in the network situation, not least because of the many small and decentralized power generators, and the conventional technology for reparametrizing the protective devices is now too inflexible to cope with the growing number of network states because the parameter sets, once permanently installed, are then no longer changed, except for new parameter sets which are fed in directly on site by a protection technician-again usually manually.

### SUMMARY

The teachings of the present disclosure include methods and apparatus for automating the adaptation of parameter sets in protective devices so that the protection technology, through automatically adapted reparameterization, copes with the growing number of network states in a power supply network due to the vast number of small decentralized energy generators. These teachings may be used to keep the number of required write operations in a protective device as low as possible.

For example, some embodiments include a method for parameterizing protective devices of a power supply network such that a plurality of devices are connected to a control station of the power supply network, of which at least one receives power from the power supply network and at least one outputs power to the power supply network, and which comprises a plurality of switching devices for controlling the power distribution within the power supply network, wherein switching states of the switching devices at a given time result in a respective network state of the power supply network, wherein a plurality of protective devices are provided for the switching devices and each protective device for the respective network state of the power supply network uses a network-state-specific parameter set to ensure a desired protection function by the respective protective device for this network state, wherein at least four parameter groups, in which parameter sets each provided with a weighting are stored, are defined in the respective protective device, wherein a parameter group represents a fallback level as the default parameter group and at least three additional parameter groups are provided in the protective device, wherein only one of the parameter groups is active in the protective device, wherein the following are carried out in the event of a change to the network state: the control station ascertains an appropriate currently adapted parameter set, the control station communicates said currently adapted parameter set to all connected protective devices, each protective device compares the currently adapted parameter set with existing parameter groups, where two cases arises: the first case is that the currently adapted parameter set is available in the protective device, then no write operation is performed, and the second case is that the currently adapted parameter set is not available in the protective device, then one of the inactive and non-default parameter groups is overwritten by the currently adapted parameter set in the protective device, wherein the parameter set to be overwritten is selected depending on the weighting and wherein, after any write operation has been performed in the protective device, there is a switch over in all connected protective devices to the parameter group containing the currently adapted parameter set.

As another example, some embodiments include a device for ascertaining and passing on parameter sets for protective devices of a power supply network, to which a plurality of devices are connected, of which at least one receives power from the power supply network and at least one outputs power to the power supply network, and which comprises a plurality of switching devices for controlling a power distribution within the power supply network, wherein switching states of the switching devices at a given time form a respective network state of the power supply network, wherein each protective device uses a network-state-specific parameter set for a respective network state of the power supply network to ensure a desired protection function for said network state by way of the respective protective device, characterized in that the apparatus has the means and is suitable for calculating and building a database containing parameter sets, to supply the contents of the database of parameter sets of the power supply network, which are calculated in advance on the basis of predictions, to the control station on the one hand and the protective devices of the power supply network on the other hand, wherein the means for calculating and building the parameter sets of the database receives, at regular time intervals, results of forecasts relating to probable network states and correspondingly appropriate parameter sets currently adapted to the respective network state.

### BRIEF DESCRIPTION OF THE DRAWINGS

In the figures, identical reference signs denote identical features and functions. The figures show:

FIG. 1 shows the prior art and a schematic block diagram of an electrical power supply network with electrical devices connected thereto, wherein the power supply network comprises electrical switching devices and protective devices for controlling a flow of power;

FIG. 2 shows four times and four scenarios which initiate typical reparameterization and switchover processes in one of the protective devices from FIG. 1; and

FIG. 3 shows a section from the communication network within an exemplary power supply network.

### DETAILED DESCRIPTION

Reparameterization optionally comprises the overwriting of a current parameter set of a parameter group in a protective device, wherein the write operation in the protective device can only take place in inactive parameter groups. Through the automatic weighting of the parameter sets to be overwritten, it is possible to minimize the number of write operations in the protective device, which is important because a write operation carries the risk of errors and is time-consuming. After optional overwriting, reparameterization is performed, triggered by the control station, wherein there is also a risk that the activation of the parameter group with the overwritten parameter set will fail. As few errors as possible should occur because, in the event that activation fails with only one protective device of the power supply network, the default parameter group is activated automatically for all protective devices of the power supply network in question so that the network remains stable.

“Means for calculating the parameter sets” may include, for example, a system comprising sensor(s), connectors, lines and/or at least one processor, with one or more optional sensor(s) being suitable for carrying out measurements that permit predictions about the expected ambient conditions, such as wind, temperature, pressure, relative and absolute humidity, UV radiation, ozone levels, and more in the region covered by the power supply network, and transmit appropriate data via lines to the processor(s). This data can also be made accessible to the system via appropriate access to the IoT. The processor, for its part, is suitable and configured to calculate expected network states based on this variable data and a predefined power supply network topology and to ascertain suitable parameter sets, which are then—for example—stored in the database and made accessible to the system. These means for calculating the parameter sets are part of a “device for ascertaining a suitable parameter set”. A suitable parameter set is ascertained by the control station as the parameter set currently adapted to the network state. In the following text, the suitable parameter set is also referred to as the currently adapted parameter set and vice versa.

The “device for ascertaining a suitable parameter set” also includes access to the database with the parameter sets that are stored, already calculated and made available in the power supply network. These parameter sets are either generally valid and/or adapted and already calculated for the power supply network in question so that they can be retrieved centrally for different network states via the device for ascertaining a suitable parameter set.

In some embodiments, the apparatus has a device for ascertaining a suitable parameter set and thus has access to a processor or a computer unit with a neural network, in which AI can be executed.

In some embodiments, the apparatus has access to IoT (Internet of Things) to be able to retrieve data from weather observations and/or weather forecasts. For example, it is possible to connect a plurality and variety of sensors, cameras, measurement and geodata devices to the control station of the power supply network via the IoT so that well-founded forecasts about the probable amount of electricity fed into the power supply network by many small power generators and/or the power consumption of many energy consumers can be predicted and/or calculated.

“Network topology” refers to the physical and/or logical arrangement of all devices and/or lines in a power supply network.

In some embodiments, the device for communication within the power supply network is designed such that provision is made of a fallback level which regularly checks the communication and, in case of any faulty and/or failing communication even between just one protective device and the control station, automatically communicates that the default parameter group with a fallback parameter set is activated by all protective devices of the entire power supply network.

In some embodiments, the switchover command to the protective devices to switch over to the parameter group with the currently adapted parameter set is output as a trigger signal and/or approximately simultaneously to all protective devices. Approximately simultaneously in this case means in a very short time in succession, for example in the period of milliseconds.

In some embodiments, forecasts of the expected network states for weighting the parameter sets are created using a recurrent neural network. For example, the means for calculating and building the parameter sets of the database can also be used for weighting a parameter set.

In some embodiments, the predictions include data regarding which network states of the power supply network are most likely due to the base load and/or the regional development of the weather, e.g. weather, wind and sun, charging states of larger storage units, presumed amount of power input and/or power consumption of the devices connected to the power supply network and availability of larger flexible storage capacities in the network.

Since the current load is dependent on the time and the previous load:

$${S}_{t} = f ( {X}_{t} , {S}_{t - 1} ) ,$$

In some embodiments, the a recurrent neural network (RNN) is used for the prediction.

The protection parameter data sets associated with a network state, characterized by a fingerprint, are stored in the parameter groups 2 . . . n of the coordinated protective devices. In the event of a change in network state, a corresponding check is carried out to determine whether and in which parameter group 2≤k≤n for the fingerprint of the new network state protection parameter data sets are already stored in the protective devices. If this is the case, a simple switchover of the activated parameter group to k is sufficient; if not, the parameter group identified as most unlikely to apply must be overwritten by protection parameters that match the fingerprint before the switchover takes place.

Each network state i can be described by a fingerprint FPi which contains the switching states Sk for the quantity of all switches k=1 . . . ns: fingerprint FPᵢ:{S₁, S₂ . . . . Sₙ_{_{S}}}
wherein switching states of the switching devices determine the possible network states of the power supply network.

In some embodiments, a communication apparatus, in which synchronization between the network states and the activated parameter sets is carried out continuously, is operated in the power supply network. A communication apparatus for carrying out this continuous synchronization is part of the so-called “fallback level”, which also includes a default parameter group in each protective device.

The one and/or the other above-mentioned synchronization can be carried out at regular time intervals, for example 50, 25, 10, 5 times or just once per day.

In some embodiments, parameter sets of all protective devices for different and/or all conceivable and/or all reasonable network states of a particular power supply network or a series of power supply networks are stored centrally in a protection data management system.

In some embodiments, the parameter sets are stored centrally in a database in a manner retrievable by the device for ascertaining suitable parameter sets for protective devices. The parameter sets can therefore be retrieved and used at any time if required. When changes are made to the network state of the power supply network, the parameter sets can be made available very easily and quickly because they only need to be retrieved from the database, for example.

In some embodiments, the device for ascertaining parameter sets for protective devices ascertains the network state of the power supply network and, depending on the ascertained network state, transmits the parameter sets to the protective devices. For this purpose, the device for ascertaining parameter sets for protective devices is preferably coupled to the power supply network, for example in the manner of an online mode, so that data in relation to the current network state of the power supply network are available on the device side. After the network state has been ascertained and the appropriate parameter sets, in particular those reduced to switches, have been retrieved from the database, the parameter sets in question can be transmitted to the respective protective devices, which then apply or use these parameter sets.

In some embodiments, the control station together with the device for ascertaining parameter sets have access to the parameter sets stored centrally in the protection data management system.

Due to an error, e.g. failure of the communication between the control station and the protective device or failure of the communication between the control station and the database, in principle, if the parameter set of a parameter group cannot be adapted successfully, the fallback level, the “default parameter group” with a fallback parameter set, is activated in all protective devices of the power supply network in question, which is important for adaptive protection, in particular to maintain the coordination and/or the network voltage in the power supply network in question.
Minimal parameter groups in the protective device: Example: There are three parameter groups per protective device: If the adaptation is successful, the network with the current network state is protected by parameters specifically adapted to the current network state.
Fallback level concept: The protective devices automatically detect a lack of communication or faulty communication with the control station and, while the communication between the control station and the protective device is failing, automatically switch to the default parameter group, where general protection parameters are stored. By activating the default parameter group, the power supply network is kept stable and protected by the general parameter set, even if the network state changes.
If faults occur during the adaptation of the parameter sets and/or reparameterization, an overwrite operation and/or the activation of a modified parameter set fails, the fallback level functions, in particular the activation of the default parameter group, are performed. The network is thus kept stable and protected.
The advantage of more than three parameter groups, in addition to the default parameter group—in the protective device: A prediction can be used to provide a likely correctly adapted parameter set in a protective device and thus reduce the reparameterization of the protective device.

The features and combinations of features cited above in the description and the features and combinations of features cited below in the following description of exemplary embodiments and/or shown in the figures may be used not just in the respectively specified combination, but also in other combinations. Embodiments which are not explicitly shown and explained in the figures, but which result and can be produced by separate combinations of features from the embodiments explained, are thus also to be considered as included or disclosed by the invention. The features, functions and/or effects shown on the basis of the embodiments can, taken in isolation, represent individual features, functions and/or effects of the invention that can be considered independently of one another and in each case also develop the teachings of the disclosure independently of each other. Therefore, the exemplary embodiments shall also include combinations other than those in the embodiments explained. In addition, the embodiments described may also be supplemented by features, functions and/or effects other than those already described.

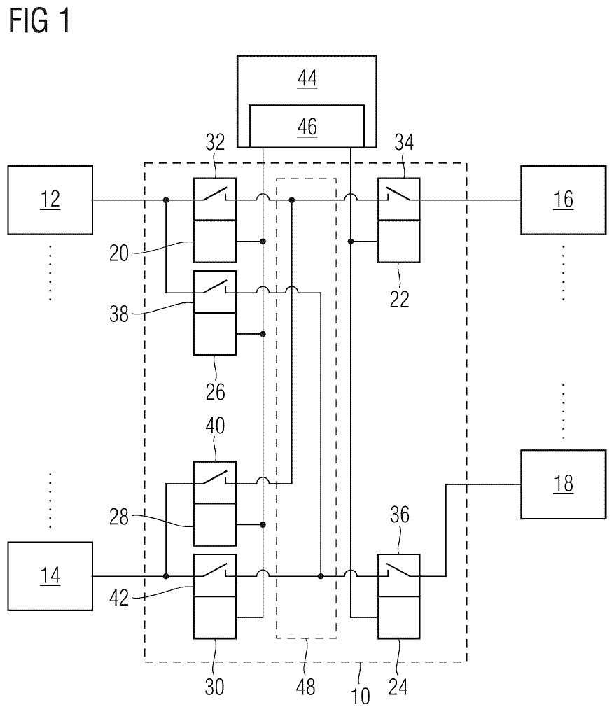

FIG. 1 shows a schematic block diagram of an electrical power supply network 10 with electrical devices 12, 14, 16, 18 connected thereto. The electrical devices 12, 14, 16, 18 may be electrical consumers, for example an industrial plant or the like, a local undersupply system for a district of a city, a wind power plant and/or similar. At least one of the devices 12, 14, 16, 18 can generate electrical power that can be consumed by at least one other of the electrical devices 12, 14, 16, 18. When the devices 12, 14, 16, 18 are operated as intended, a respective one of the devices 12, 14, 16, 18 may also change its operating state with regard to the power consumption. For example, an industrial plant may output electrical power over a certain period of time, while it takes up electrical power over a different period of time.

The electrical devices 12, 14, 16, 18 are connected to the power supply network 10. The electrical power is distributed between the devices 12, 14, 16, 18 via the power supply network 10. FIG. 1 shows only four devices 12, 14, 16, 18. However, it is possible that significantly more electrical devices are connected to the electrical power supply network 10.

In order to distribute the electrical power between the devices 12, 14, 16, 18, the power supply network 10 establishes corresponding electrical connections using electrical lines that can be controlled by means of switching devices 32, 34, 36, 38, 40, 42 of the power supply network 10. Said switching devices make the electrical lines of a network topology 48 of the power supply network 10 available as required.

The power supply network 10 also includes protective devices 20, 22, 24, 26, 28, 30 that are assigned to respective switching devices 32, 34, 36, 38, 40, 42 in the present case. In alternative exemplary embodiments, this may also be different since protective devices can be arranged independently of switching devices.

The protective devices 20, 22, 24, 26, 28, 30 serve to detect one or more state data of the power supply network 10, such as an electrical current, an electrical voltage, a temperature and/or similar, at a certain local position and to initiate switching measures, for example with respect to the protective devices 20, 28, 24, 26, 22, 30. In addition, the protective devices 20 to 30 have a communication link with a control station 44 of the power supply network 10.

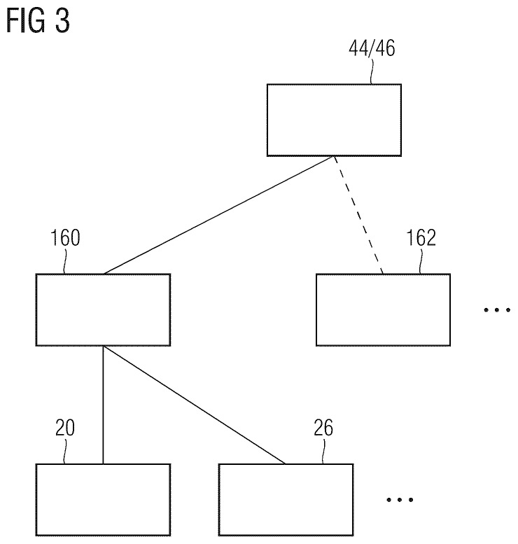

The communication link is effected, for example, via the station control system 160, 162—see FIG. 3.

The switching states of the switching devices 32 to 42 at a predefined time form a respective network state of the power supply network 10. Each protective device 20 to 30 uses a respective individual, network-state-specific parameter set for a respective network state of the power supply network 10 in order to implement a desired protection function for said network state by way of the respective protective device 20 to 30.

The switching devices 32 to 42 can be designed, for example, as circuit breakers, as power circuit breakers or as disconnecting switches. Combinations of these can also be provided as switching devices 32 to 42. The switching devices 32 to 42 do not need to be of identical design.

The control station 44 has a device 46 for ascertaining a suitable parameter set for the protective devices 20 to 30 of the power supply network 10. The device 46 for ascertaining a suitable parameter set is designed to evaluate the operating-state-specific parameter sets for at least one of the protective devices 20 to 30 in order to ascertain switching-device-reduced parameter sets that are independent of switching states at least one of the switching devices 32 to 42. This will be explained in even more detail below.

The protective devices 20 to 30 have a communication link—e.g. also via the device 46 for ascertaining a suitable parameter set for the protective devices 20 to 30—with the control station 44, so that data and/or signals from the protective devices 20 to 30 can be retrieved, received, sent and/or requested. At the same time, parameter sets can be transmitted from the control station 44 to the respective protective devices 20 to 30, so that the protective devices 20 to 30 can adjust their protection function in a manner adapted to the current operating-state-specific parameter set.

For this purpose, provision may be made, on the one hand, for the respective network-state-specific parameter set to be applied to be transmitted from the control station 44 to the respective protective device 20 to 30, so that the respective protective device 20 to 30 currently, preferably directly, applies the received operating state-specific parameter set. On the other hand, provision may be made for the respective network-state-specific parameter set to be applied in the protective device to already be stored in a parameter group.

In some embodiments, part of the communication network is also the device 46 for ascertaining a suitable parameter set, via which the control station 44 can currently retrieve suitable parameter sets, said device either having stored a suitable parameter set or being configured and suitable for recalculating same. The device 46 for ascertaining a suitable parameter set comprises, for example, a processor which provides calculations and results using AI and/or is connected, for example, to the Internet of Things “IoT”.

The control station 44 can retrieve and compare the currently active parameter sets of protective devices 20 to 30, for example, also via the protection control system 160 and 162. The protective device also receives control commands from the control station 44 via the protection control system 160/162 and can supply the required information. The protective devices themselves control which parameter group is activated according to the control commands received. The protective devices also receive current-voltage signals, in time-resolved form, so that the protective device can detect whether or not the current-voltage signals indicate an error in the network by reading these signals. In particular, the protective device can select parameter groups, activate them and overwrite the parameter sets in selected parameter groups.

The quantity of all parameters of a protective device, e.g. protective devices 20 to 30, that are adaptive with respect to the network states is referred to as—in short—“parameter set” or—in full—“parameter protection data set” or “protection parameter data set”.

“Parameter group” refers to the number of the group of the protective device in which a parameter set can be stored. Members of a parameter group are parameter protection data sets, in particular numbered memory locations in the protective device, which can each contain a protection parameter data set.

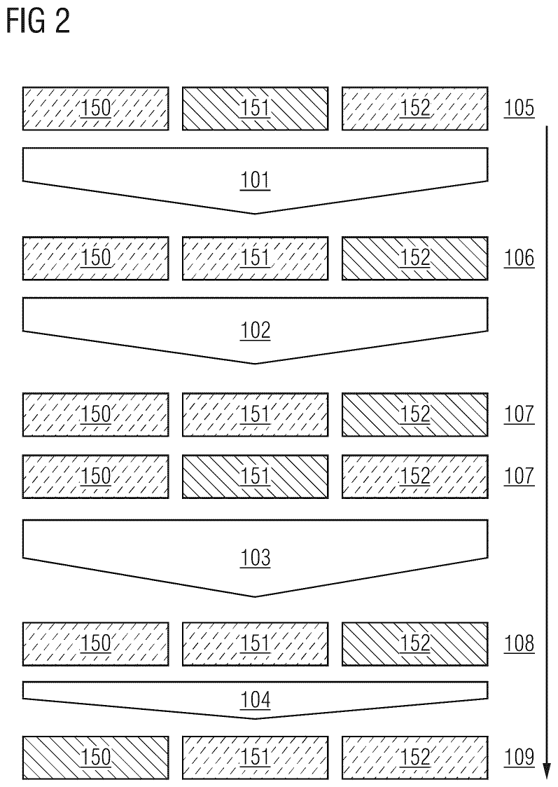

Using the example of a protective device with three (3) parameter groups, FIG. 2 shows by way of example some scenarios as well as reparameterization and switchover processes.

The wide sequence arrows 101, 102, 103 and 104 represent times T1 to T4 and thus illustrate a time sequence with different scenarios and parameterization states 105 to 109 of the protective device shown.

At least three parameter groups 150, 151 and 152 are defined in protective devices 20 to 30 for adaptive protection by the protective devices of the power supply network. In the exemplary embodiment shown in FIG. 2, the generally valid “default protection parameters” are stored in the “default” parameter group 150.

The values of a power supply network stored in the “default parameter set” are not changed within the scope of an exemplary method according to the invention, because they serve as a fallback level and protect the network reliability of a power supply network 10 from a failure, for example if the communication between the control station 44 and one or more of the protective devices 20 to 30 is not functioning. For example, all protective devices 20 to 30 are designed—see FIG. 3 and description—in such a way that, in the event of an omission of and/or an error in the communication between the control station 44, or device 46 for ascertaining a suitable parameter set and one or more of the protective devices 20 to 30, they switch over to the default mode.

In addition, the default parameter group is automatically activated if it is determined via communication with control station 44 that the protective devices are not coordinated, for example if the switchover and/or the overwriting to the currently adapted parameter set has not worked for one or more switching devices of a power supply network. For example, the control station and/or the device 46 for ascertaining a suitable parameter set identifies this using means for communication in the power supply network and/or sends a corresponding control command to all protective devices. Accordingly, the default parameter set is used not only in the event of communication faults, but also if the coordination is not complete. This is an advantage of the technology, because it enables the protection system to react faster.

For example, the “means of communication” or “apparatus for communication” comprise(s) two communication networks within the power supply network 10.

The control station 44 for its part registers approximately simultaneously the loss of communication with one or more of the protective device(s) 20 to 30 and communicates to all still communicatively connected protective devices that there is to be a switch over to default, because the communication in the power supply network is at least partially faulty and/or has broken off.

In the case shown here in FIG. 2 of a protective device with at least three parameter groups, one of which is the unchangeable default parameter group 150, there are still two parameter groups 151 and 152, between which it is possible to switch back and forth and which can be overwritten via communication with the control station 44.

The protection parameters specific to a respective network state are stored, the active and an alternative, in these two parameter groups 151 and 152. If a change in the network state, present at time 105, is detected, the control station 44 provides an adapted protection parameter data set via the corresponding apparatus for communication via the protective control system 160, 162—known to those skilled in the art, but not shown here in the overview—to the protective device(s). For this purpose, the control station 44 ascertains a parameter protection data set adapted to the change or searches for this from the device for ascertaining a suitable parameter set, in particular there from the database of the protection data management system.

The protective device receives the adapted parameter set and stores it locally in a parameter group that is neither active at the time nor the default parameter group. In the present case of only three parameter groups (for the sake of the clarity of the illustration, only three parameter groups are displayed) in the protective device, only one parameter group would be possible to select, in the case that the parameter group 151 is currently active, the parameter group 152 would be possible to select because parameter group 150 is the default parameter group. At time 106, a new network state is then specified in the present case and the parameter group 152 has the parameters adapted to the new network state. At time 106, the parameters present in the parameter group 152 are overwritten accordingly and the activation of the parameter group 151 stops and there is a switch over to activation of the parameter group 152.

For communication with the control station 44, each protective device 20 to 30 has an apparatus for communication, in this case the interface with connected control and monitoring function, in which all parameter groups are monitored and the state of the parameter groups, whether they are activated or not and for which network state adapted parameters are stored in the respective parameter groups, is stored.

Two options are possible here: (a) the control station 44 has the information about which parameter groups 150, 151, 152, 153 are stored in the protective devices 20 to 30 and/or which of them are active, or (b) this information is stored centrally in the device 46 for ascertaining a suitable parameter set, which may communicate with the control station 44 and the station control system 160 and 162. The latter is assumed here as an example.

This control and monitoring function of the protective device shown in FIG. 2 determines at time 106 after successful overwriting of the parameter group 152 and after successful switchover of the parameter groups and activation of the parameter group 152 that the parameter group 151 does not yet have any parameters adapted to the new network state—time 105.

For this reason, at the time T2, 106, when the parameter group 152 is active, the parameter group 151 is overwritten in the protective device by the parameters adapted to the new network state, scenario 102.

In the time sequence shown in FIG. 2, the activity should be switched over from the parameter group 152 back to the parameter group 151 in the protective device at time T3, 107, after the parameter group 151 has been rewritten.

However—scenario 103—this switchover operation to the parameter group 151 does not work at time T3. This results in the scenario that, although the parameter group 151 has been successfully overwritten, the activity of the protective device cannot be switched over to this newly overwritten parameter group—time T4, scenario 108. This is not yet a case for the fallback level, but the activity of the parameter group 152 is retained.

For example, consider the protective devices 20 and 22. At time T3 (102), the parameter groups of the protective devices 20 and 22 are switched over from 152 to 151. The switchover process to 151 of the parameter groups of the protective device 20 is successful, but the switchover of protective device 22 is not. A corresponding piece of information that in protective device 20 the parameter group 151 and in protective device 22 the parameter group 152 are activated reaches the means for communication with the control station 44/46, whereby it is also clear that the parameter group 152 of protective device 22 cannot be switched over. Therefore, the control command to switch the parameter group in the protective device 20 back from 151 to 152 from the control station 44/46 arrives at the protective device 20 in order to maintain the coordination of all protective devices in the power supply network.

As an example of the illustration shown in FIG. 2, the switchover of the parameter group 152 to the currently overwritten parameter group 151 does not work at time T4, or 108, as described above. In principle, the switchover to the newly overwritten parameter group 151 is attempted; if this attempt fails, at time T4, at 108, it is initially retained in parameter group 152 in all protective devices.

This changes after the time T4, as shown in scenario 109, at which one or more protective devices lose the communication link with the control station 44. At 109, after time T4, the communication of the protective devices within the power supply network and with the control station 44 at least partially collapses. All protective devices then automatically switch to the default parameter group 150, which is the fallback level concept provided for this purpose, in which the default parameter groups of the protective devices are activated to maintain network reliability.

In the reparameterization and switchover processes, as shown in FIG. 2, the protective devices 20 to 30 within a power supply network 10 are matched and coordinated among one another and with one another.

In the event of successful reparameterization of the non-activated parameter group 152, there is a switch over to the overwritten parameter group 152.

FIG. 3 shows an example of a communication network within a power supply network 10 incorporating teachings of the present disclosure. From the control station 44 at the top, which is coupled to the device 46 for ascertaining a suitable parameter set—the coupling is represented in the figure by the reference numeral 44/46—one or more, in particular two, communication network(s) go to all protective devices. The communication network runs here via the respective station control system 160 and 162, which controls one or more protective devices. If the communication between the station control system 162 and the control station 44 exhibits faults or even breaks down completely—see dashed line between 44/46 and 162, then this triggers in the station control system 162 the fact that the protective devices 22, 24 connected to this station control system—shown here only by dots—receive the signal from the station control system 162 to activate the default mode; in the example shown in FIG. 2, this would be parameter group 150. At the same time, the control station 44/46 will detect the error in the communication between the station control system 162 and the control station 44/46 and transmit this information via the still functioning communication—solid line between 44/46 and 160 of the station control system 160, whereupon the station control system 160 instructs the protective devices 20 and 26 connected to it to also activate the parameter group 150—from FIG. 2—with the default parameter set.

The communication proceeds—as shown in FIG. 3—from the control station 44/46 to the station control system 160 and 162 and from there to the assigned protective devices 20, 26 and others, symbolized by dots. The apparatus for communication in this case comprises, in particular, two or more communication networks.

Provision is made for the number of non-default parameter groups within a protective device to be greater than the minimum, i.e. 3, so there is the weighting in which the non-active parameter groups of a protective device are overwritten so that the number of overwrites is kept as low as possible because each overwrite also carries a risk of an error and/or an incorrect or even non-functioning activation. The weighting of the parameter sets thus reduces the frequency of overwriting and thus the risk of faults.

Each parameter set has a weighting, a value which determines the order in which this parameter set is overwritten. This does not affect the default parameter group. This remains the same and is not overwritten during operation because this would override the fallback level concept.

In particular, each parameter set has a weighting and the parameter group of the stored parameter set with the lowest weighting is overwritten—if necessary—by a new parameter set.

An example of this would be the case where a protective device has 4 parameter sets and 4 parameter groups. The default parameter set is stored in parameter group 1 and must not be changed. The remaining 3 of the 4 protection parameter data sets are stored in the parameter groups 2, 3 and 4 with parameter sets a, b and c of the protective device. It is assumed that the appropriate parameter sets of the protective device will repeat each day according to the following series. The resulting weighting is subsequently referred to as “empirical” or “historical” weighting.

| t | 1 | 2 | 3 | 4 | 5 | 6 | 7 | 8 | 9 | 10 | 11 |
|---|---|---|---|---|---|---|---|---|---|---|---|
| Appropriate | a | b | a | b | a | d | c | b | d | c | a |
| parameter set | | | | | | | | | | | |

The weightings of the parameter sets are:

| Parameter set | Weighting |
|---|---|
| a | 4 |
| b | 3 |
| c | 2 |
| d | 2 |

At the beginning, the parameter sets a, b, and c are stored in the parameter groups 2, 3, and 4. If the parameterization is carried out according to the embodiment with the weighting of the parameter sets, the protective device is parameterized 5 times:

| t | 1 | 2 | 3 | 4 | 5 | 6 | 7 | 8 | 9 | 10 | 11 |
|---|---|---|---|---|---|---|---|---|---|---|---|
| Appropriate | a | b | a | b | a | d | c | b | d | a | c |
| parameter set | | | | | | | | | | | |
| Stored and activated | abc | abc | abc | abc | abc | abd | acd | acb | adb | adb | acb |
| parameter set | | | | | | | | | | | |
| Parameterization | 0 | 0 | 0 | 0 | 0 | 1 | 1 | 1 | 1 | 0 | 1 |

The stored parameter sets at time 1 and 11 are the same. If the series of appropriate parameter sets is not changed, the reparameterization is repeated daily.

In some embodiments, network state changes are calculated and predicted based on predicted, precalculated and/or meteorological data, for example loads of the power supply network occurring regularly, weather forecasts with regard to power feeds into the power supply network, specific calendar features, etc., by means of AI. A new parameter set from the control station is then written via the parameter set identified as most unlikely and weighted the lowest. Such a weighting is subsequently referred to as “predicted weighting” as opposed to “empirical weighting”.

Predictions of the power feed and the loads and the resulting changes in network state resulting within a certain time horizon (e.g. 24 h, 48 h, or 72 h) are predicted based on weather forecasts. The adapted parameter sets can be derived from this and predicted weightings for the parameter groups 150, 151, 152, 153 in the protective devices 20 to 30 can be assigned from this so that the least weighted parameter set is overwritten. This enables the number of write operations for currently adapted parameter sets and thus the risk of errors to be minimized.

With the assumption of the correct prediction, if the reparameterization according to this embodiment of the invention—with connection of AI and/or the IoT—is carried out, the protective device is parameterized only 3 times:

| | Day 1 | | | | | | | | | | |
|---|---|---|---|---|---|---|---|---|---|---|---|
| t | 1 | 2 | 3 | 4 | 5 | 6 | 7 | 8 | 9 | 10 | 11 |
| Appropriate | a | b | a | b | a | d | c | b | d | a | c |
| parameter set | | | | | | | | | | | |
| Stored and activated | abc | abc | abc | abc | abc | adc | adc | bdc | bdc | adc | adc |
| parameter set | | | | | | | | | | | |
| Parameterization | 0 | 0 | 0 | 0 | 0 | 1 | 0 | 1 | 0 | 1 | 0 |

| | Day 2 | | | | | | | | | | |
|---|---|---|---|---|---|---|---|---|---|---|---|
| t | 1 | 2 | 3 | 4 | 5 | 6 | 7 | 8 | 9 | 10 | 11 |
| Appropriate | a | b | a | b | a | d | c | b | d | a | c |
| parameter set | | | | | | | | | | | |
| Stored and activated | adc | adb | adb | adb | adb | adb | cdb | cdb | cdb | cda | cda |
| parameter set | | | | | | | | | | | |
| Parameterization | 0 | 1 | 0 | 0 | 0 | 0 | 1 | 0 | 0 | 1 | 0 |

On the second day, the stored parameter sets at time 1 and 11 are the same. If the row of the appropriate parameter set is not changed, the parameterization will be repeated.

In the example, it can be seen that the method of empirical or historical weighting requires 5 reparameterizations, but the method of predicted weighting only requires 3 reparameterizations per day.

Accordingly, the method of “empirical weighting” does not bring any advantage in terms of reducing the number of parameterizations, but is superior only to a so-called “predicted weighting”, which works via predictions using AI, in terms of data security and independence from incorrect predictions.

For the predicted weighting, as in the second exemplary embodiment, the next m possible network states should be predicted, for example, until the sum of the parameterization equals n−3. For example, on the second day at time 2, 4 further up to sixth possible network states are predicted. On the second day at time 7, only one other network condition needs to be predicted.

For example, a recurrent neural network is used to predict which network states (network topologies) are most likely to occur due to the base load and regional weather development (wind and sun), charging states of larger storage units and the availability of larger flexible loads in the network.

The current load is dependent on the time and the previous load:

$${S}_{t} = f ( {X}_{t} , {S}_{t - 1} ) ,$$

for this reason, for example, a recurrent neural network is used for the prediction.

The vector representation of this relationship—see formula above—is:

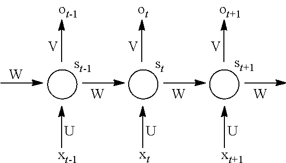

Vector representation of an RNN-recurrent neural network where U, V, W=weightings
Oₜ=the network state at time t
Sₜ=Oₜ (start)
Xₜ=the information (e.g. base load and regional weather development (wind and sun), charging states of larger storage units and availability of larger flexible loads) at time t. The values can be predicted separately.

The associated protection parameter data sets are stored in the parameter groups 2 . . . n of the coordinated protective devices. In the event of a change in network state, a corresponding check is carried out to determine whether and in which parameter group 2≤k≤n for the fingerprint of the new network state protection parameter data sets are already stored in the protective devices. If this is the case, a simple switchover of the activated parameter group to k is sufficient; if not, the parameter group arising as most unlikely to apply must be overwritten by protection parameters that match the fingerprint before the switchover takes place.

The stability and reliability of a power supply network are specifically improved by the invention because the protective devices are automatically parameterized adaptively in accordance with a network state. The invention provides technology using which, on the one hand, appropriate predictions are made via suitable AI and currently adapted parameter sets are calculated from this and, on the other hand, a parameterization directly adapted to the current network state is carried out automatically in the respective protective devices via communication. Minimizing write operations reduces the likelihood of errors.

Systems and methods using the teachings of the present disclosure may offer considerable advantages over the, until now, customary manual reparameterization of parameter groups within a protective device or over adaptive protection systems, in which each change in network state requires write operations of adapted parameter sets because, on the one hand, it enables automated switchover as soon as all protective devices have parameter groups comprising the currently adapted parameter set and because the invention use the weighting to specify a sequence of overwriting to the parameter sets which minimizes the number of write operations in the respective protective device.

List of reference signs

| | |
|---|---|
| 10 | Power supply network |
| 20, 22, 24 | Protective device |
| 26, 28, 30 | Protective device |
| 32, 34, 36 | Switching device |
| 38, 40, 42 | Switching device |
| 44 | Control station |
| 46 | Device for ascertaining a suitable |
| 101 | Time T1 |
| 102 | Time T2 |
| 103 | Time T3 |
| 104 | Time T4 |
| 105 | Scenario at time T1 |
| 106 | Scenario at time T2 |
| 107 | Scenario at time T3 |
| 108 | Scenario at time T4 |
| 109 | Scenario after time T4 |
| 150 | Default parameter group |
| 151 | Parameter group |
| 152 | Parameter group |
| 160, 162 | Station control system |

1. A method for parameterizing protective devices of a power supply network having a plurality of devices connected to a control station of the power supply network, of which at least one device of the plurality receives power from the power supply network and at least one of the plurality transfers power to the power supply network, and wherein the power supply network comprises a plurality of switching devices to control power distribution within the power supply network, wherein switching states of the switching devices at a given time define a respective network state of the power supply network, wherein the power supply network further include a plurality of protective devices for the switching devices, and each protective device uses a network-state-specific parameter set for the respective network state of the power supply network to ensure a desired protection function for said network state using the respective protective device, the method comprising:
storing four parameter groups with weighted parameter sets in the respective protective device, wherein a parameter group represents a fallback level as the default parameter group, wherein only one of the parameter groups is active in the protective device at any given time;
in the event of a change in the network state, ascertain an appropriate currently adapted parameter set using the control station;
communicating said currently adapted parameter set to all connected protective devices;
comparing the currently adapted parameter set with existing parameter groups at each protective device and:
if the currently adapted parameter set is available in the respective protective device, then no write operation is performed; and
if the currently adapted parameter set is not available in the respective protective device, then overwriting one of the inactive and non-default parameter groups with the currently adapted parameter set in the respective protective device, including selecting the parameter set to be overwritten based on the weighting; and
after any write operation has been performed in the protective device, switching over in all connected protective devices to the parameter group containing the currently adapted parameter set.

2. The method as claimed in claim 1, further comprising providing a fallback level to regularly check the apparatus for communication and, in case of any faulty and/or failing communication between a respective protective device and the control station, automatically communicating that the default parameter group with a fallback parameter set is activated by all protective devices of the entire power supply network.

3. The method as claimed in claim 2, wherein the default parameter group with the fallback parameter set cannot be overwritten.

4. The method as claimed in claim 1, further comprising assigning a weighting for each parameter set specifying a sequence in which the parameter set in the protective device is overwritten.

5. The method as claimed in claim 4, wherein the weighting comprises a predictive weighting.

6. The method as claimed in claim 4, wherein the weighting comprises an empirical weighting.

7. The method as claimed in claim 1, wherein the control station comprises a device to ascertain a currently adapted parameter set, the device programmed to predict most likely network states to be expected.

8. The method as claimed in claim 1, further comprising operating a communication apparatus, in which synchronization between the current network states and the activated parameter groups is carried out continuously.

9. The method as claimed in claim 1, further comprising operating communication apparatus in which synchronization between the predicted network states and the activated parameter groups is carried out continuously.

10. The method as claimed in claim 8, carried out at regular time intervals.

11. The method as claimed in claim 1, further comprising retrieving a parameter set from the device for determining the currently adapted parameter set with the control station.

12. The method as claimed in claim 1, further comprising, before providing and sending the currently adapted parameter set, checks whether the corresponding parameter set is available in the protective devices using the control station.

13. The method as claimed in claim 1, further comprising checking whether a suitable and corresponding parameter set for the current network state is stored in the protection data management with the device for ascertaining a currently adapted parameter set.

14. An apparatus for ascertaining and passing on parameter sets for protective devices of a power supply network connected to a plurality of devices, including at least one device receiving power from the power supply network and at least one device transferring power to the power supply network, wherein the power supply network comprises a plurality of switching devices to control a power distribution within the power supply network, wherein switching states of the switching devices at a given time form a respective network state of the power supply network, wherein each protective device uses a network-state-specific parameter set for a respective network state of the power supply network to provide a desired protection function for said network state by way of the respective protective device, the apparatus comprising:
a processor for calculating and building a database containing parameter sets, to supply the contents of the database of parameter sets of the power supply network, calculated in advance on the basis of predictions, to a control station of the power supply network and the protective devices,
wherein the processor receives, at regular time intervals, results of forecasts relating to probable network states and correspondingly appropriate currently adapted parameter sets and/or means for calculating their weighting.

15. The apparatus as claimed in claim 14, further comprising a transceiver to connect the control station of the power supply network, a device for ascertaining a suitable parameter set, station control technology, switching devices, and protective devices.

16. The apparatus as claimed in claim 14, further comprising connectors between the power supply network and a protection data management system.

17. The apparatus as claimed in claim 14, wherein the processor is configured and suitable for using artificial intelligence for ascertaining a currently appropriate parameter set.
